(19) United States
(12) Patent Application Publication
(10) Pub. No.: US 2025/0180817 A1
(43) Pub. Date: Jun. 5, 2025

(54) STRESS-CONTROLLED PACKAGING SCHEME FOR FIBER-BASED OPTICAL DEVICES

(71) Applicant: OFS Fitel, LLC, Norcross, GA (US)

(72) Inventors: Lalitkumar Bansal, Belle Mead, NJ (US); David J DiGiovanni, Mountain Lakes, NJ (US); Robert Sienkowski, Hamilton, NJ (US)

(73) Assignee: OFS Fitel, LLC, Norcross, GA (US)

(21) Appl. No.: 18/843,787

(22) PCT Filed: Mar. 3, 2023
(86) PCT No.: PCT/US2023/014543

§ 371 Date: Sep. 4, 2024

Related U.S. Application Data
(60) Provisional application No. 63/316,662, filed on Mar. 4, 2022.

(51) Int. Cl. G02B 6/36

(52) U.S. Cl. CPC G02B 6/3628; G02B 6/3608

(57) ABSTRACT

A packaging scheme for a fiber-based optical device includes a substrate for supporting the fiber-based optical device, with a set of individual adhesive bonds used to affix the device to the substrate. Individual bonds are placed along the length of the device in a manner that reduces the possibility of fiber movement subsequent to packaging, even in the presence of changes in ambient temperature over the lifetime of the packaged optical device.

### CROSS-REFERENCE TO RELATED APPLICATIONS

This application claims the benefit of U.S. Provisional Application No. 63/316,662, filed Mar. 4, 2022 and herein incorporated by reference.

### TECHNICAL FIELD

Disclosed herein is a packaging scheme particularly configured for use with a fiber-based optical device and, more particularly, to a packaging scheme including the use of a series of individual bonds formed along the length of the device in a manner that reduces the possibility of fiber movement subsequent to packaging, even in the presence of changes in ambient temperature over the lifetime of the packaged optical device.

### BACKGROUND OF THE DISCLOSURE

In many applications, fiber-based optical devices need to withstand an operating temperature range of −40C to +85C (for example). Over this wide temperature range, any significant mismatch in the coefficient of thermal expansion (CTE) between the packaging material housing the device and the optical fiber device itself introduces stresses onto the device. The stresses may result in introducing unwanted bends along the optical fiber device, which can lead to compromises in optical signal quality and/or mechanical integrity of the packaged arrangement.

In the optical domain, the appearance of bends along an optical fiber span beyond a defined radius of curvature can result in out-coupling of a portion of a propagating signal (i.e., bend-induced loss). Depending on the type of optical fiber device and application, unwanted bending may also introduce mode coupling between different optical modes that may be supported by the bent fiber. From the mechanical point of view, changes in stress experienced by an optical fiber device under load (such as a load related to temperature-related contraction of the package with respect to the optical fiber device) are most problematic along zones that have already experienced mechanical weakening as a result of the fabrication process. The need to perform one or more heat treatments during the fabrication/formation of optical devices, for example, may result in creating various regions of different mechanical characteristics.

In the formation of a tapered fiber bundle, a defined segment of the collected fibers needs to be subjected to an elevated glass-softening temperature that will fuse the individual fibers together. Simultaneously, the collected fibers are subjected to a longitudinal force that tapers down the fused collection of fibers (forming a fused taper). As a result of this heat treatment process, a fabricated TFB will have a mechanically weakened region encompassing the interface between the individual fibers and the fused taper. In particular, this weakened region may be referred to as a “hot/cold interface”, where the “hot region” corresponds to the portion of the device subjected to heat treatments (e.g., fusion) and the “cold region” corresponds to non-processed elements (such as the initial collection of optical fibers).

In addition to thermal processes causing weakened areas to form, mechanical processes (such as stripping of outer layers from fibers), environmental processes (such as handling of individual fibers during device assembly), etc., may introduce mechanically-weakened regions within a fiber-based optical device.

It is well known that glass corrosion may occur within any mechanically weakened region of an optical device if preventative measures are not taken. The corrosion may be attributed to a presence of moisture as part of the ambient conditions when a fusion process is initiated (for example). Some specific heat treatments used for fusion are known to also create moisture as a by-product.

The glass corrosion affects the optical fiber device structure within a weakened region, leaving the structure susceptible to the propagation of cracks along the length (and across the width) of the optical fiber device. A CTE mismatch between the packaging material and the glass of the optical fiber may introduce mechanical stress (by virtue of the created thermal stresses). These various results of glass corrosion remain problematic for the lifetime of the packaged optical device, and may result in breakage of the optical device at some point in the future.

Any of these created mechanically weakened zones may be further compromised when the final optical fiber device is packaged within a material with a relatively high CTE, since there are various materials that otherwise exhibit desired properties such as a high rate of thermal conductivity.

As fiber-based optical devices are increasingly being used in conditions that subject a packaged device to extremes in temperature (as well as other environmental conditions), the choice of material for use in packaging, as well as the design details for encasing the device within the package, become more important. Indeed, both mechanical failure and optical impairments are dependent on changes in the radius of curvature of the packaged optical fiber device, which in this case may be triggered by temperature-based changes in the physical size of the packaging (particularly contraction) with respect to the fiber-based optical device. To that end, there is a desire to minimize the possibility of fiber movement once the fiber-based optical device is packaged, regardless of changes in stress on the fiber related to differences in CTE between the fiber and the packaging material.

### SUMMARY OF THE DISCLOSURE

The issues mentioned above are addressed by the present disclosure, which relates to a packaging scheme particularly configured for use with a fiber-based optical device such as a tapered fiber bundle (TFB) and, more particularly, to a packaging scheme including the use of a series of individual bonds formed along the length of the device in a manner that reduces the possibility of fiber movement subsequent to packaging, even in the presence of changes in ambient temperature over the lifetime of the packaged device.

A packaging arrangement for an optical fiber device is proposed that is based upon selection of a suitable material (or combination of materials) for use as the mounting substrate of the optical fiber device, in combination with the use of a series of individual bonds to affix the optical fiber device to the mounting substrate in a manner that reduces the possibility of fiber movement within the packaged device when thereafter exposed to extreme ambient conditions (for example, a low temperature extreme of a defined operating temperature range). For the purposes of discussion, a “suitable material” may be one that exhibits a relatively high rate of thermal conductivity, with its CTE being a property of secondary consideration.

In an exemplary embodiment, a packaging arrangement is proposed where selected, individual bonds may be located such that identified mechanically weakened regions along the optical device are supported between a pair of bonds. Said another way, the bond locations are selected such that mechanically weaker sections of an optical fiber device remain in compression for a pre-defined load range that is expected over the lifetime of the optical fiber device.

In many instances, the pre-defined load range is a function of the extremes of an operating temperature range of the packaged optical fiber device, since there is typically a substantial difference in CTE between the packaging material and the glass fiber, the packaging material contracting relative to the glass fiber at low temperatures and imparting stress on the optical fiber device.

In another embodiment, a packaging arrangement may be configured such that the lengths of unsupported fiber between individual bonds are not subjected to bending beyond a radius of curvature (even in the presence of compressive loads caused temperature extremes) at which bend-induced coupling loss and/or mode coupling of the propagating signal arises.

A particular bond may be formed to extend to cover a complete length of a certain feature of an optical fiber device (e.g., the fused taper feature of the TFB); in other embodiments only a portion of a selected feature may be covered by the adhesive bond.

It is to be understood that while the following discussion is primarily focused on the formation of a fiber-based optical device in the form of an optical combiner including a TFB that exhibits at least one mechanically-weakened zone by virtue of its fabrication process, the same principles apply to the packaging of any fiber-based optical device that may experience substantial, unwanted bending as a result of mechanical, thermal and/or environmental factors. The fiber-based optical devices may range from the simple optical splice to complex multiple fiber-based assemblies, and used in various types of applications including communication systems, sensors, medical devices, etc.

Various embodiments of the disclosed package may incorporate the use of one or more specific CTE-matched substrate insets, positioned in proximity to identified mechanically weakened location(s) or fiber spans where bending beyond a known radius of curvature compromises the quality of the propagating optical signal, while the remainder of the substrate is formed of a material with the preferred heat transfer properties.

An exemplary embodiment of the disclosure may take the form of a packaging arrangement for a fiber-based optical that comprises a substrate for supporting the fiber-based optical device (the substrate formed of material that may experience contraction relative to the fiber-based optical device at low temperature extremes) and a plurality of bonds for fixing the fiber-based optical device to the substrate. The plurality of bonds is disposed along a length of the fiber-based optical device such that unsupported sections of optical fiber between a pair of bonds are restricted from either bending beyond a defined radius of curvature, or breaking in a mechanically-weakened zone, during operation of the fiber-based optical device across a defined temperature range.

Other and further features and embodiments will become apparent during the course of the following discussion and by reference to the accompanying drawings.

### BRIEF DESCRIPTION OF THE DRAWINGS

Referring now to the drawings, where like numerals represent like parts in several views:

FIG. 1 is a cross-sectional view of an optical combiner including a tapered fiber bundle (TFB);

FIG. 2 is an isometric view of a typical prior art packaging arrangement for the optical combiner shown in FIG. 1;

FIG. 3 is a cut-away side view of the prior art packaging arrangement illustrated in FIG. 2;

FIG. 4 contains diagrams illustrating the onset of two different buckling modes based on Euler's critical load analysis, diagram (a) associated with a first (fundamental buckling mode and diagram (b) associated with a subsequent (second) buckling mode;

FIG. 5 contains graphs illustrating variations in the data shown in FIG. 4 as a function of change in the CTE of the package used to support an optical fiber device;

FIG. 6 plots the buckling load factor (BLF) as a function of unsupported length L for the mechanically-weakened hot/cold interface region within a simple 2×1 optical combiner;

FIG. 7 contains simplified diagrams of strategic positioning of bonds to support a mechanically-weakened hot/cold interface region as found within the TFB portion of an optical combiner; and

FIG. 8 contains plots of BLF as function of unsupported fiber span lengths for a variety of different tapered fiber bundle configurations.

### DETAILED DESCRIPTION

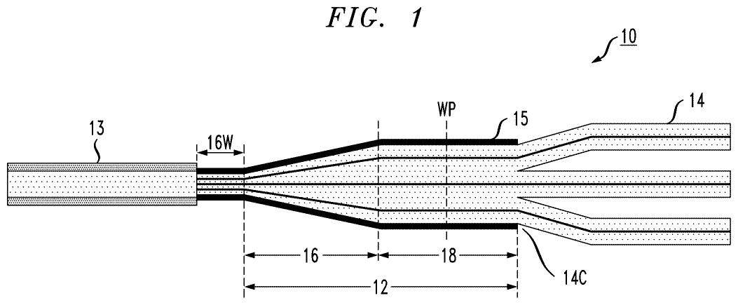

FIG. 1 is a cross-sectional view of an optical combiner 10 including a tapered fiber bundle (TFB) 12 and an output optical fiber 13. For the purposes of the present invention, tapered fiber bundle 12 is described and characterized by its heat treatment history, which directly impacts its ability to maintain stability after being packaged. Again, it is to be understood that while the following discussion is primarily focused on the formation of an optical combiner including a TFB, the same principles apply to the packaging of optical fiber devices that may include mechanically-weakened sections created during fabrication by any type of mechanical process, thermal process, product handling environment, etc. Additionally, beyond designing a particular package configuration to avoid failure/breakage in mechanically-weakened zones, the inventive packaging scheme may be used to develop a device package that minimizes the possibility of an unsupported length of packaged fiber bends beyond a radius of curvature that may introduce optical impairment.

TFB 12 is shown in FIG. 1 as formed from a plurality of N individual fibers 14, which are stripped of outer jacket layers and assembled into a closely-packed collection configuration 14C. Closely-packed collection 14C is thereafter subjected to multiple heat treatments to soften the glass and fuse the individual fibers together, while also applying a drawing force to taper the diameter of the fused bundle. A tapered fusion region 16 is also shown in FIG. 1, which terminates into a tapered waist 16W that is spliced or otherwise coupled to output fiber 13.

Of particular importance for the present disclosure, a hot/cold interface region 18 forms in a zone between tapered fusion region 16 (which has been subjected to thermal processes in the form of one or more heat treatments at glass-softening temperatures) and closely-packed fiber collection 14C (which has not been further processed). The glass composition of interface region 18 is mechanically weakened during the fusion process, primarily due to moisture corrosion of glass, driven by the presence of moisture associated with ambient conditions (or perhaps the heat source used for the fusion process, such as an H₂—O₂ flame torch). Glass corrosion weakens the structure of interface region 18 by forming cracks along the surface of the bundle, where the cracks may thereafter propagate along the longitudinal (or radial) direction of tapered fiber bundle 12 in the presence of tensile stress. Ultimately, the glass corrosion may result in glass failure by mechanical fracture. The corrosion is typically at a maximum along a weakened plane WP within interface region 18, which is a location of first inspection upon the recognition of a mechanical failure. In practical situations, it is common for the fiber strength in a weakened region to be reduced to 20 kpsi (from a nominal value of about 100 kpsi), or even as low as 10 kpsi.

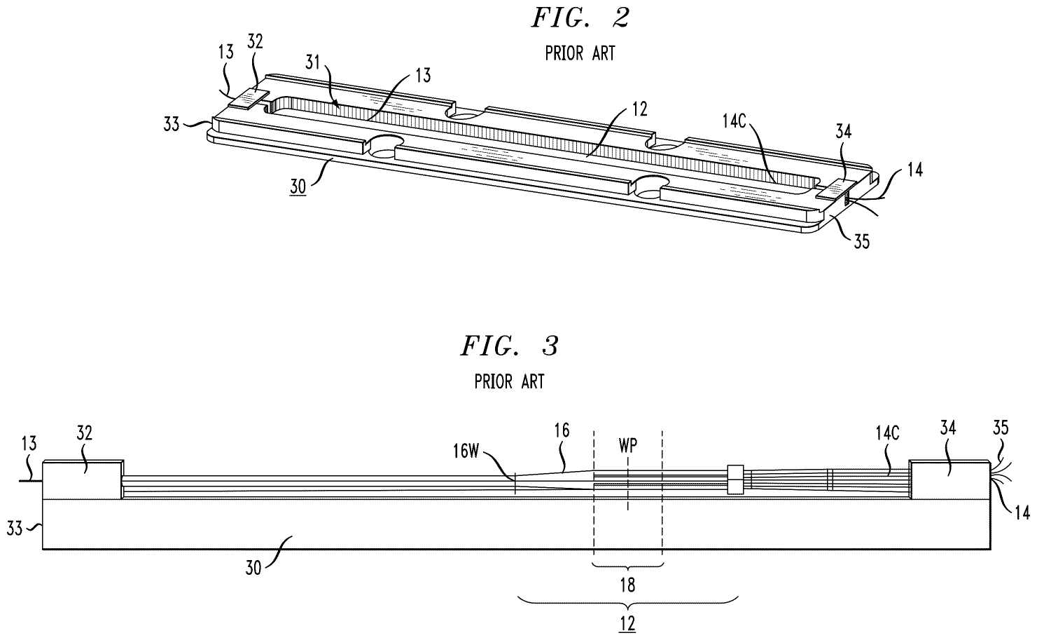

FIG. 2 is an isometric view of a typical prior art packaging arrangement for optical combiner 10 of FIG. 1, with a cut-away side view of the prior art packaging arrangement illustrated in FIG. 3. As shown in FIGS. 2 and 3, optical combiner 10 is positioned on a substrate 30 that is formed of a material with a thermal conductivity value sufficient to provide heat sinking functionality. Aluminum is a typical choice for substrate 30, since the thermal conductivity of aluminum is relatively high (about 200 W/mK), but other materials may be used, particularly in applications where the heat-sinking requirements can be relaxed.

As best shown in FIG. 2, substrate 30 may be formed to include recessed areas 31 to support various sections of optical combiner 10. In this prior art configuration, optical combiner 10 is held in place within recesses 31 on substrate 30 by a pair of adhesive bonds 32, 34, positioned at opposing end terminations of substrate 30. Bond 32 is shown as affixed to a portion of output fiber 13 at a first end termination 33 of substrate 30, and bond 34 is shown as disposed to hold closely-packed fibers 14C in place at a second end termination 35 of substrate 30.

As mentioned above, tapered fiber bundle 12 (particularly the mechanically weakened interface region 18) can experience tensile stress as a result of a CTE mismatch between the material selected for substrate 30 and the glass material of optical combiner 10. In many applications, the material selected for use as the packaging material is chosen based on having a high value of thermal conductivity (i.e., excellent heat sinking capability); the CTE mismatch is a secondary consideration. The specific nature of the thermal stresses is a function of whether the ambient temperature of the packaged optical combiner is above or below a “strain reference temperature,” which is typically room temperature (and associated with zero strain). In situations where the ambient temperature is above the strain reference temperature, a substrate 30 formed of a high-CTE material will expand with respect to optical combiner 10, thus applying tensile stresses to the packaged optical device. Below the strain reference temperature, the high CTE material will contract and thus apply compressive stresses to the optical fiber device. It is the latter situation that leads to the types of optical signal impairments and mechanical failures addressed and overcome by the disclosed packaging solution.

The detailed characteristics of structural changes of an optical fiber device in the presence of compressive stress may be understood by using Euler's boundary conditions derived for a “slender member.” In particular, Euler's critical load is defined as the compressive load at which a slender column will suddenly bend or buckle:

$${P}_{cr} = \frac{{π}^{2} EI}{{( KL )}^{2}} ,$$

where E is the Young's modulus of the column material (here, the specific glass composition of the optical fiber device), I is the minimum area moment of inertia of the cross-section of the column, L is defined as the unsupported length of the column, and K is the column effective length factor. As shown by this relation, the critical load (P_{cr}) at which a column may suddenly buckle is inversely proportional to the square of the length of the unsupported column.

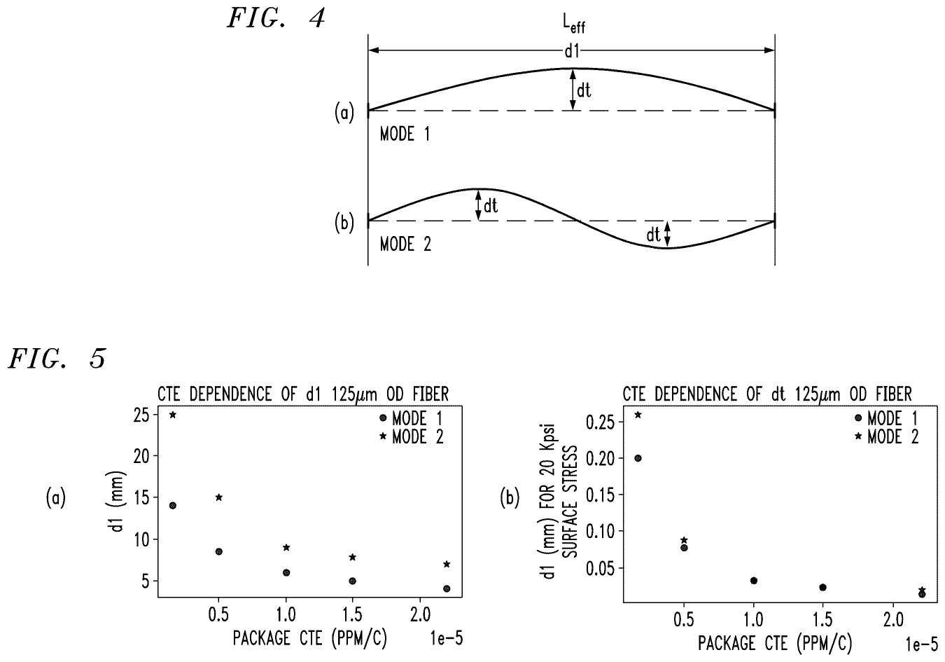

The effective length factor K relates to whether or not the ends of the column can rotate or translate. For conditions in which the ends cannot rotate or translate, such as is in the present case where the epoxy bonds (e.g., 32, 34) hold opposing ends in place, the K factor is defined to have a value of 0.5 (which thus halves the length L at which a critical load may occur, L_{eff}=0.5 L). FIG. 4 is a diagram illustrating the onset of two different buckling modes for a column of length L_{eff}=KL fixed between two endpoints, with each particular buckling mode having its own critical load value. Diagram (a) illustrates a first (fundamental) mode of buckling, with a second, higher mode of buckling is shown in diagram (b). The maximum displacement (dt) is also shown in both diagrams. Referring to the fundamental buckling mode shown in diagram (a), it is possible that this type of buckling may be permissible for a packaged optical device, if the surface tensile stress created in buckling is less than a predefined maximum allowable tension. The radius of curvature associated with the first mode shown in diagram (a) is less than that of mode 2 as shown in diagram (b), where the radius of curvature is an important factor when designing bond placements to address optical coupling issues, such as minimizing the possibility of bend-induced loss when the packaged optical fiber device is exposed to extreme low temperatures.

Applying Euler's critical load analysis to the conventional packaging arrangement shown in FIGS. 2 and 3, the length L of the unsupported column includes all of the individual components of optical combiner 10; namely, closely-packed fiber collection 14C, tapered fiber bundle 12, and output fiber 13. Commercially available optical combiners may have a length L within the range of about 25-100 mm, depending on the physical parameters of the combiner (including the number of individual fibers being bundled together). Inasmuch as the critical load is inversely proportional to the square of the length of an unsupported fiber span, this relatively long span L results in a small value for P_{cr}, meaning that even a small contraction in package size may create a load greater than the critical value. When using a conventional package with a relatively high CTE value, this P_{cr} value may limit the temperature range over which the device may be used without experiencing buckling and related mechanical problems (including breakage), or optical signal integrity problems, such as the onset of bend-induced loss or unwanted mode coupling. As well-understood in the art, the bending of an optical fiber changes its effective refractive index value, which leads to the possibility that a bend of a certain amount will create a change in effective index that supports coupling into another (unwanted) mode. The out-coupling of a propagating signal is a known result of a fiber bend beyond some radius of curvature, and is a function of the particular fiber design.

FIG. 5 contains two plots illustrating the changes in unsupported fiber span length (dl) and the associated changes in peak transverse fiber movement(dt) for a variety of different CTE values. Plot (a) shows the change of length dl required for the onset of mode 1 and mode 2 buckling as the CTE of the package material increases. As shown, increases in the CTE of the package material results in significant decreases in acceptable lengths of unsupported fiber spans for both of these buckling modes. Also shown in these results is that for relatively low CTE values, the unsupported length related to the onset of mode 2 buckling is about twice that of mode 1, with the gap between the two lengths lessening as the package CTE becomes greater than about 1.0e−5. The changes in maximum displacement (dt) as a function of CTE, as shown in plot (b) are relatively the same for both buckling modes for CTE values greater than about 1.0e−5. Unfortunately, there are few (if any) material choices for packaging of fiber-based optical devices that exhibit a CTE in this lower range while also providing the required high level of thermal conductivity.

These difficulties of the prior art are addressed by the present invention, which relates to the configuration of a packaging arrangement for optical fiber devices that utilizes strategically-placed bonds (that may or may not be free to rotate and translate). In particular, the individual bonds are placed such that unsupported lengths of the device (i.e., the length between two bond sites) does not exceed the value where bending/buckling of the fiber could be triggered when the packaged device is exposed to low temperature extremes. Inasmuch as the CTE for a given package material is typically greater than that of the optical fiber, the contraction of the package material at low temperatures introduce a load onto the device, where it is desired to control this applied load with respect to the known critical load value.

For the particular case of evaluating bond placement around a mechanically-weakened area of a fiber, the goal is to have the area remain in compression. By controlling the placement of bonds in this area so that only relatively short spans of the optical fiber device are unsupported, the mechanically-weakened region is able to withstand a much higher load compared to the prior art arrangement of FIGS. 2 and 3) before any bending occurs (the bending defined as including buckling of the mechanically-weakened device region, as well as the situation where although the bending remains less than a known radius of curvature the maximum surface stress exceeds the strength of the device). With respect to maintaining acceptable optical transmission properties, the length(s) of unsupported fiber need to be such that any bending remains less than a known radius of curvature where bending loss may occur. With reference to FIG. 4, it is clear that the radius of curvature is related to the buckling mode that is excited.

As described below, the inventive packaging configuration takes into consideration both the critical load P_{cr} described above and an applied load Pₐₚ. The applied load Pₐₚ is defined in this case as the compressive load applied to a packaged optical fiber device by the shrinkage/contraction of substrate 30 with respect to the optical fiber device at the low end of the defined operating temperature range for device. The ratio of P_{cr}/Pₐₚ may be defined as the “buckling load factor” (BLF), where values of BLF greater than unity may be preferred to minimize the chance that buckling will occur (i.e., P_{cr}>Pₐₚ) into a particular mode with particular end conditions. As discussed below, the larger the value of BLF, the more likely that the unsupported mechanically-weakened section of an optical fiber device will remain in compression when exposed to extremes in operating conditions (e.g., low temperature boundary of a defined operating temperature range).

Therefore, in accordance with the teachings of the present invention, the sites for the bonds are selected and spatially located such that each known area of mechanical weakness along the optical fiber device (for example, interface region 18 of optical combiner 10) is located between a pair of bonds. As a result, the length L of the “unsupported column/fiber” (e.g., interface region 18) is determined such that the unsupported fiber remains in compression (or, at worst, experiences minor surface tensile stress) even when the supporting package substrate has contracted to its smallest size, associated with the lowest operating temperature permitted for the application of the packaged optical fiber device.

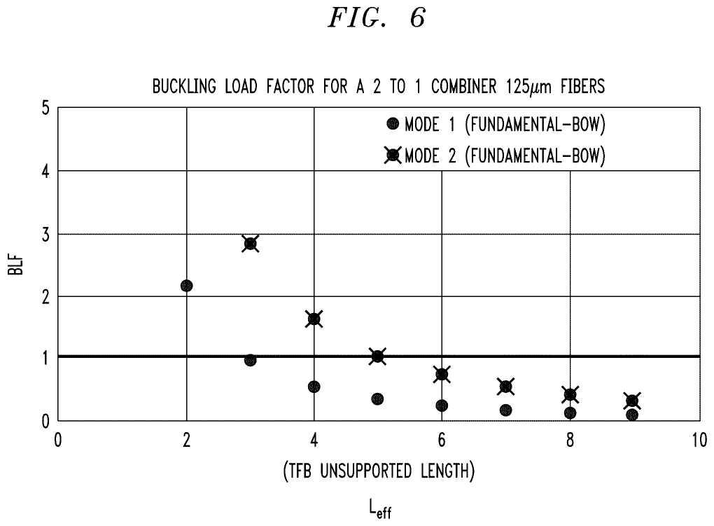

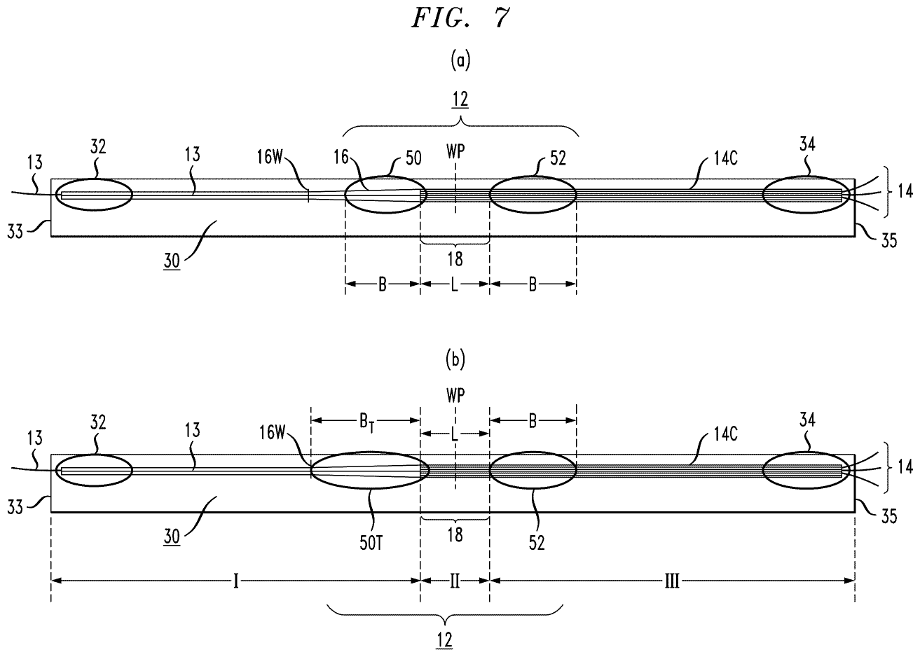

A simple optical combiner may take the form of a 2×1 combiner, wherein a pair of input fibers are fused together and tapered to be spliced to an output fiber. For example, each of the input fibers may have an original outer diameter of 125 μm, and the output fiber may also have an outer diameter of 125 μm. FIG. 6 plots the buckling load factor (BLF) as a function of unsupported length L for the mechanically-weakened hot/cold interface region within this simple 2×1 combiner. Looking at the results, it is shown that buckling in the first mode (illustrated as diagram (a) in FIG. 4) may occur for an unsupported length L greater than 3 mm. Buckling in the second, higher mode (diagram (b)) may not appear until the unsupported length L goes beyond 5 mm. The maximum surface tensile stress for buckling in the second mode can be an order of magnitude higher than that associated with the fundamental mode. Similarly, optical degradation caused by the second buckling mode can be significantly higher than for the first mode. Because the maximum surface tensile stress (and optical degradation discussed above) depends on the radius of curvature at the bend, buckling in the fundamental mode may be permissible while buckling in the second or third mode could cause catastrophic failure.

FIG. 7 contains simplified diagrams of strategic positioning of adhesive bonds to support the mechanically-weakened hot/cold interface region 18 with TFB 12 of optical combiner 10. For the purposes of discussion and clarity, the bonds are shown as “open” elements so that the underlying sections of optical combiner 10 are shown. FIG. 7(a) illustrates an exemplary positioning of a pair of bonds 50, 52 with respect to interface region 18 of TFB 12 (particularly, surrounding the weakened plane WP within region 18). Also referred to at times as “interior bonds” (with respect to the position of outer bonds 32, 34), bonds 50 and 52 are positioned such that the unsupported fiber length L is relatively short and interface region 18 remains in compression at the extreme lowest temperature associated with the operation of optical combiner 10. As a result, this short length is able to withstand a relatively high applied load before buckling (i.e., exhibits a high BLF). Examples of some calculated values will be discussed below. The arrangement of FIG. 7(a) also shows the inclusion of bonds 32, 34, used to further support the physical attachment of optical combiner 10 to metal substrate 30. For example, a preferred embodiment of an arrangement of optical combiner 10 includes a plurality of four bonds (shown here, in sequence, as bonds 32, 50, 52, and 34) to maintain all segments of the assembly in a straight line and under compression at low operating temperatures, thus avoiding mode coupling of propagating signals at these temperatures. In some optical combiner designs, it is desired to maintain mode coupling between the desired fundamental mode and all other higher-order modes (primarily in the LP₁₁ mode) to a value of less than 15db; this is only one example.

Another factor that may be taken into consideration when determining bond configurations is the physical length of the bond attachments disposed to surround mechanically weakened areas of an optical fiber device. The diagram of FIG. 7(b) illustrates embodiment illustrating this bond length factor. In this particular embodiment, a first adhesive bond 50T is shown as having a length BT greater than B. In this particular example of optical combiner 10, the length BT may be chosen such that adhesive bond 50T completely covers tapered region 16 (as opposed to the configuration shown in FIG. 7(a), where adhesive bond 50 only covered a portion of tapered region 16.

Example configurations of the present invention as shown in FIG. 7 may be referred to as “four-point” bonding of optical combiner 10, supporting three adjacent segments of combiner 10 on heatsinking metal substrate 30. A first segment I is shown in FIG. 7 as corresponding to output fiber 13, and is supported between first termination bond 32 and first interior bond 50. A second segment II corresponds to the hot/cold interface region 18 of TFB 12 and is supported between interior bonds 50 and 52. A third segment III corresponds to the “cold” area of optical combiner 10; that is, the closely-packed collection of individual optical fibers 14 and is supported between second interior bond 52 and second termination bond 34. The properties of these three segments will be described below, particularly illustrating the improvement in BLF for interface region 18 when supported between interior bonds 50, 52.

In one example related to the bond placement and sizes as shown in FIG. 7(a), metal substrate 30 was formed of aluminum, and a minimum operating temperature for optical combiner 10 was defined as −40° C., yielding an applied load Pₐₚ=−37 N attributed to aluminum shrinkage. Segment I was defined as having a length L₁ of 22 mm, with segment III having the same length (L_{III}=L_{I}). Interface segment II (including weakened plane WP) had a length L_{II} of 5 mm. Using the relations described above, P_{cr} for segment II was calculated to be −532N, based on L_{II}=5 mm. For these values and assuming that the endpoints are free to rotate, the BLF (i.e., P_{cr}/Pₐₚ)was calculated to be 14.48, well in excess of the desired condition of BLF>1 to avoid buckling, and thus ensuring that interface region 18 will remain in compression (i.e., not buckle) at this extreme ambient temperature value.

In contrast, the P_{cr} for segment I was calculated to be only −4.3 N, with an associated BLF of 0.11 (recall that Pₐₚ has a value of −37 N). The results for segment III were similar, with a P_{cr} of −31.5 N and a BLF of 0.85. Since the loading factors for both segments I and III are less than unity, these two segments may experience buckling at the low temperature extreme in some instances, it may be desirable to avoid buckling in segments I and III as well; that is, to minimize the possibility of buckling occurring along any portion of the optical device, such as to minimize the possibility of optical impairments in terms of bend-induced loss or unwanted mode coupling.

As mentioned above, some prior art solutions for addressing buckling of optical fiber devices at low package temperatures are related to using a substrate metal material that exhibits CTE similar to the glass material of the optical fiber device. For example, a nickel-iron alloy known as Invar has a CTE of 1.5e−6/C, which is relatively close to that of glass (about 0.50e−6/C) and thus minimizes the change in size of the substrate as a function of temperature (e.g., minimizes its contraction relative to optical fiber for the lowest temperature value within the operating range). However, Invar does not exhibit the degree of thermal conductivity that is typically required for applications of a packaged optical fiber device (i.e., a thermal conductivity of 12 W/mK, as compared to 220 W/mK for aluminum). One approach may be to utilize a hybrid substrate that utilizes a material of reduced CTE in areas of the package supporting the weakened area(s)—such as Invar—and aluminum (or another material with a similarly high CTE and high thermal conductivity} for the remainder of the package substrate. In another approach, an inset of a material with a reduced CTE may be disposed within recessed areas of the aluminum substrate, positioning the inset in the weakened area(s) most impacted by compressive stress (e.g., interface region 18, segment II as shown in FIGS. 7(a) and (b)). In this case, the allowable length between bonds can be determined based on the CTE of the material to which the device is bonded and the desired maximum surface stress allowed over the desired temperature range.

Continuing with a description of specific experimental results based on the parameters defined above, the addition of Invar in segment II raises the Pₐₚ at −40° C. (reduces in magnitude) to −2.2 N. The addition of Invar raised the value of P_{cr}(lower magnitude) in segment II to a value of −228 N. As a result, the BLF for the Invar-loaded segment II becomes about 103 for bond regions that allow rotation and buckling into the fundamental mode, a significant improvement over the value of about 14 associated with the all-aluminum substrate.

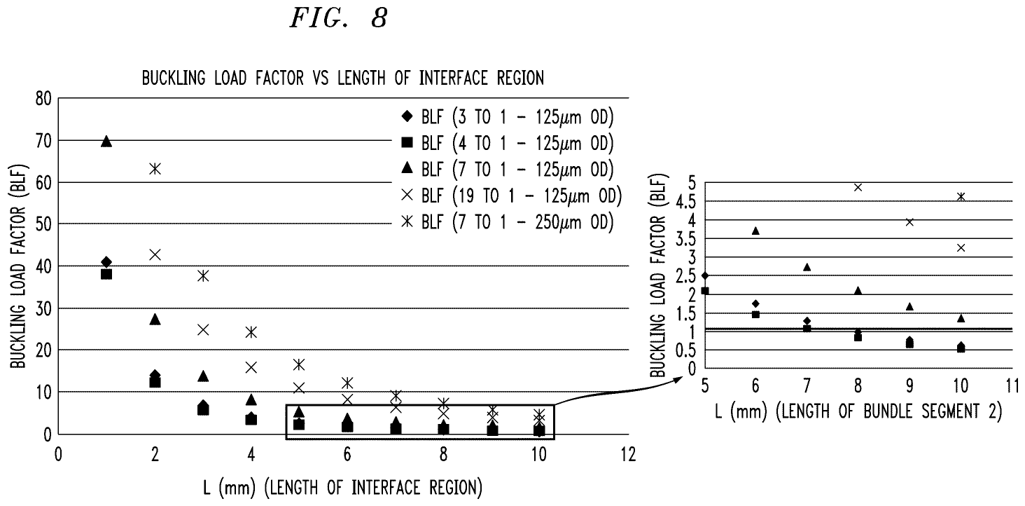

The BLF is obviously also impacted by the length of the mechanically weakened region(s) supported between a pair of bonds. In the examples described above, interface region 18 is defined as the weakened region (including the weakened plane WP). For the above examples (and with reference to FIG. 6), segment length L_{II} was defined as 5 mm. FIG. 8 contains plots of the buckling loading factor as function of length L_{II} for a variety of different tapered fiber bundles (ranging from a 3×1 configuration to a 19×1 configuration, all based on the bundling of individual fibers having an outer diameter of 125 μm). As shown is a plot of BLF vs L_{II} for a 7×1 configuration of fibers with an outer diameter of 250 μm. An expanded area of the plot is also shown in FIG. 7, showing in a larger BLF scale the L_{II} values where the BLF approaches the unity threshold.

It should be noted that the scope of the present invention is not limited to the preferred embodiments described above, but that various modifications and changes may be made by those skilled in the art without departing from the inventive concept and scope as defined by the claims appended hereto.

What is claimed is:

1. A packaging arrangement for a fiber-based optical device, comprising:
a substrate for supporting the fiber-based optical device, the substrate formed of material that experiences contraction relative to the fiber-based optical device at low temperature extremes; and
a plurality of bonds for fixing the fiber-based optical device to the substrate, the plurality of bonds disposed along a length of the fiber-based optical device such that an unsupported section of the fiber-based optical device of length L between a pair of bonds is restricted from either one of: (1) bending beyond a radius of curvature at which bend-induced impairment occurs, and (2) breaking in a mechanically-weakened zone along the unsupported section during operation of the fiber-based optical device across a defined temperature range.

2. The packaging arrangement as defined in claim 1, wherein the defined length L is defined as a function of a critical buckling load P_{cr}, where
$${P}_{cr} = \frac{{π}^{2} EI}{{( KL )}^{2}} ,$$
and E is a Young's modulus of the glass material of the fiber-based optical device, I is a minimum area moment of inertia of the cross-section of the fiber-based optical device, and K is a column effective length factor equal to 0.5 for an unsupported length disposed between a pair of fixed points.

3. The packaging arrangement as defined in claim 2, wherein a buckling load factor (BLF) is used in a determination of the defined length L, the BLF defined as a ratio of P_{cr} to a maximum load Pₐₚ applied as a compressive load on the unsupported section of the fiber-based optical device.

4. The packaging arrangement as defined in claim 3 wherein the maximum load Pₐₚ is related to a maximum contraction of the substrate at a lowest temperature value within the operating temperature range.

5. The packaging arrangement as defined in claim 4 wherein the defined length L is chosen such that the BLF is greater than one.

6. The packaging arrangement as defined in claim 1, wherein the substrate comprises aluminum.

7. The packaging arrangement as defined in claim 1, wherein the fiber-based optical device operates over a temperature range of −40° C. to +85° C.

8. The packaging arrangement as defined in claim 1, wherein the plurality of bonds further comprises a pair of termination bonds located at opposing ends of the metal substrate.

9. The packaging arrangement as defined in claim 1, wherein the fiber-based optical device includes a mechanically-weakened zone within the unsupported section.

10. The packaging arrangement as defined in claim 9 wherein the defined length L is selected such that the mechanically-weakened zone remains in compression across the operating range of the packaged fiber-based optical device below a temperature associated with zero stress on the packaged fiber-based optical device.

11. The packaging arrangement as defined in claim 10, wherein the substrate comprises a hybrid of at least two different materials with two different CTE values, a first material with a lower CTE value disposed in proximity to the mechanically-weakened zone.

12. The packaging arrangement as defined in claim 11, wherein the first material with the lower CTE value takes the form of an inset disposed within a recessed area of the substrate in proximity to the mechanically-weakened zone.

13. The packaging arrangement as defined in claim 11, where the hybrid of at least two different materials comprises aluminum and Invar.

14. The packaging arrangement as defined in claim 19 wherein the fiber-based optical device includes a tapered fiber bundle having a mechanically-weakened zone section at an interface between an input section comprising a plurality of closely-packed optical fibers and an output section comprising a fused, tapered joining of the plurality of optical fibers.

15. The packaging arrangement as defined in claim 1 wherein the plurality of bonds are spaced apart by an amount such that each unsupported section of the fiber-based optical device exhibits a radius of curvature unable to support mode coupling and bend-induced loss at a low temperature extreme of the defined temperature range.
